(19) United States
(12) Patent Application Publication
(10) Pub. No.: US 2009/0242380 A1
(43) Pub. Date: Oct. 1, 2009

(54) Rotary-Heat-Exchanger Flow Control

(76) Inventor: William H. Zebuhr, Nashua, NH (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/059,512

(22) Filed: Mar. 31, 2008

(51) Int. Cl. B01D 3/42; B01D 3/08

(52) U.S. Cl. 203/2; 202/175

(57) ABSTRACT

A rotary heat exchanger includes an evaporation chamber in which sprayers spray a feed liquid to be purified onto the surfaces of heat-exchange members, which heat it and cause some of it to evaporate. The remaining, un-evaporated feed liquid is collected by a rapidly spinning sump, from which scoops skim the spinning sump liquid and direct it back to the sprayers. To make the rate at which feed liquid is supplied to the heat exchanger match that at which the sprayed liquid evaporates, a regulator bases its control of a flow-controlling valve's flow resistance on the internal pressure that prevails in one of the scoops.

### BACKGROUND OF THE INVENTION

1. Field of the Invention

The present invention is directed to distillers, particularly those of the sort that employ rotary heat exchangers.

2. Background Information

Distillation is probably the single most effective approach to purifying water. But it has historically been too costly for widespread use. Distillation requires that the water evaporate. Without energy recovery, the energy of vaporization alone would cost something on the order of fifteen to twenty cents per gallon or more. Theoretically, that cost can be reduced by recovering and reusing the heat of vaporization. For most small-scale distillation applications, though, the equipment available until now has not had the capability of recovering enough heat to make distillation affordable.

But small, low-component-cost distillers of more-recent designs have exhibited high efficiencies. For example, I have built a fire-plug-sized prototype that can produce distilled water at an operating cost of less than half a cent per gallon. That prototype was based substantially on the design described in U.S. patent application Ser. No. 11/691,211, which was filed on Mar. 26, 2007, by William H. Zebuhr for a Vapor-Compression Distiller and is hereby incorporated by reference.

In that design, the influent to be purified is heated to near its saturation temperature and sprayed onto heat-exchange surfaces in the evaporation chamber of a rotary heat exchanger. Such a heat exchanger uses centrifugal force to keep the liquid film on its heat-exchange surfaces much thinner than surface tension would ordinarily permit. As a consequence, those surfaces transfer heat of vaporization to the influent very efficiently.

A compressor draws the resultant vapor from the evaporation chamber, leaving contaminants behind. The compressor raises the vapor's pressure and delivers the higher-pressure (and thus higher-saturation-temperature) vapor to the rotary heat exchanger's condensation chamber. In that chamber, thermal communication with the evaporation chamber results in the vapor's condensing into a largely contaminant-free condensate, surrendering its heat of vaporization in the process to the feed liquid in the evaporation chamber. The rotary heat exchanger thereby recovers the heat of vaporization efficiently.

Rotary heat exchangers of that type and others are ordinarily so operated that the rate at which the feed liquid evaporates in the evaporation chamber is only a small fraction of the rate at which it is sprayed onto the heat-exchange surfaces. In the above-mentioned prototype, in fact, eighty to ninety percent of the sprayer flow remains liquid. The rapidly spinning heat-transfer surfaces fling that un-evaporated liquid into an annular feed-water “sump” formed by centrifugal force. Scoop tubes skim liquid from that sump and route it back to the sprayers. The distiller therefore needs only to be supplied ten to twenty percent as much feed liquid at its inlet as is sprayed onto its heat-exchange surfaces: it should draw in only enough feed liquid to make up for evaporation. Drawing in more or less feed liquid than that would ultimately flood or deplete the sump. So the feed-water flow rate has to be so regulated as to match the evaporation rate.

### SUMMARY OF THE INVENTION

I have devised a simple way of controlling feed-water flow: I so position the sprayer-supplying scoop that its internal pressure varies with sump depth, and I base the control of feed-liquid flow on that pressure. Specifically, the distiller reduces feed-liquid flow in response to increases in that pressure, and it increases feed-liquid flow in response to decreases in that pressure. The average feed-water flow thereby tends to match the average evaporation rate.

### BRIEF DESCRIPTION OF THE DRAWINGS

FIG. 1 is an isometric view that depicts a distiller of the type in which the present invention can be employed.

FIG. 2 is an isometric view of that distiller's compressor/rotary-heat-exchanger assembly.

FIG. 3 is a simplified cross-sectional view of the rotary heat exchanger showing the conduit by which feed liquid is supplied to its sump.

FIG. 4, too, is a simplified cross-sectional view of the rotary heat exchanger, but one taken at a different plane to show the scoops.

FIG. 5 is an isometric view of a feed-liquid regulator used in the distiller of FIG. 1.

FIG. 6 is a cross-sectional view of that regulator.

### DETAILED DESCRIPTION OF AN ILLUSTRATIVE EMBODIMENT

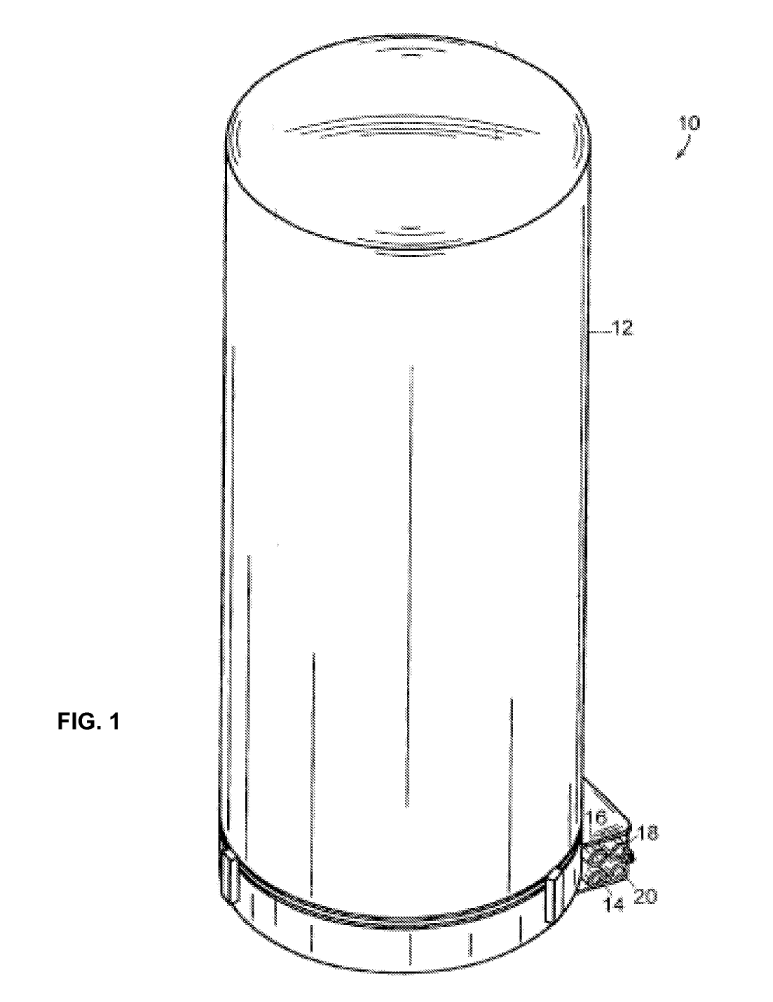

FIG. 1 depicts a distiller 10 enclosed by an insulating jacket 12. Feed liquid to be purified or concentrated enters a feed inlet 14. Concentrate, condensate, and volatile impurities respectively leave through concentrate, condensate, and vent outlets 16, 18, and 20. Although the present invention can be used in all kinds of distillation, such as purifying water or condensing orange juice, we will assume in this example for the sake of concreteness that the purpose is water purification and that the feed liquid is therefore water that contains contaminants to be removed.

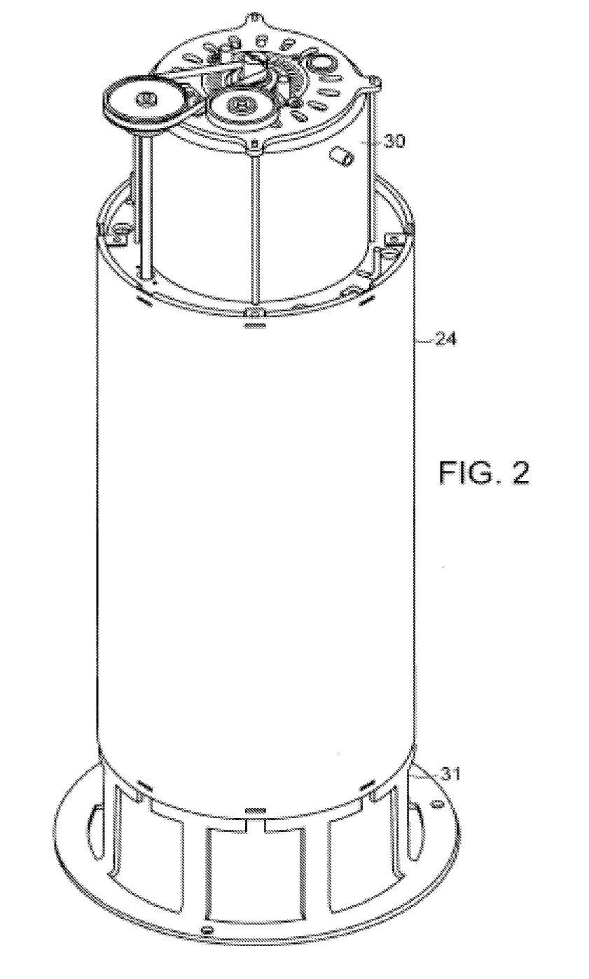

In addition to a counterflow heat exchanger, pump, and control circuitry largely omitted from the drawings, the insulating jacket 12 encloses a compressor/rotary-heat-exchanger assembly of which FIG. 2 is an isometric view. That assembly can be thought of as divided into three subassemblies characterized by respective different rotational speeds. Part of the first, stationary subassembly is made up of a generally cylindrical shell that comprises an external cylindrical side wall 24 and top and bottom end walls. A motor 30 for driving the system's other two subassemblies is mounted on the top end wall. The bottom end wall is mounted on a platform, identified in FIG. 2 by reference numeral 31, that supports the rotary heat exchanger above the previously mentioned pump and a flow regulator to be described in due course.

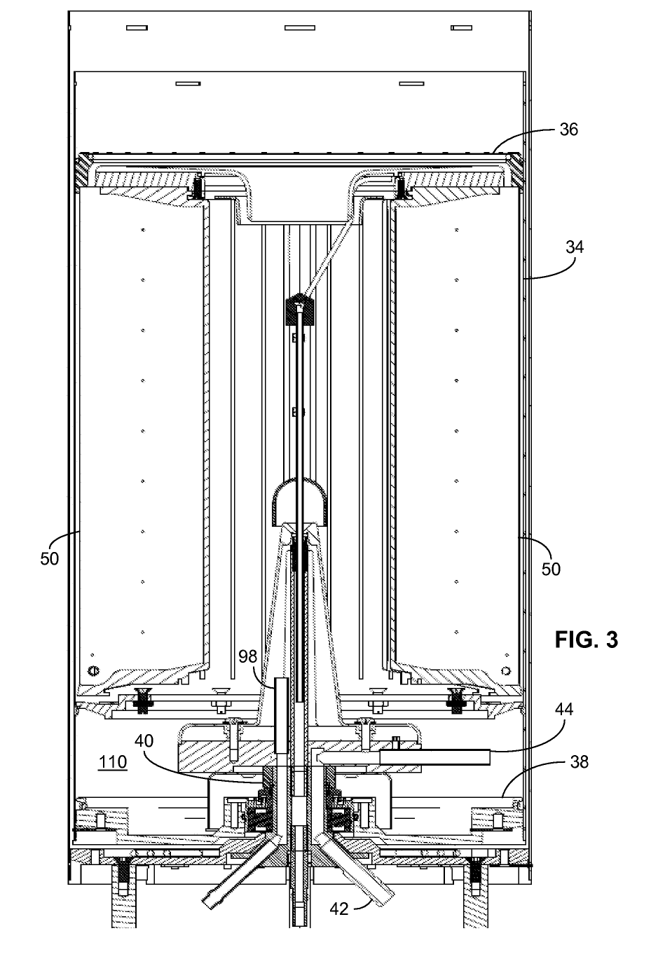

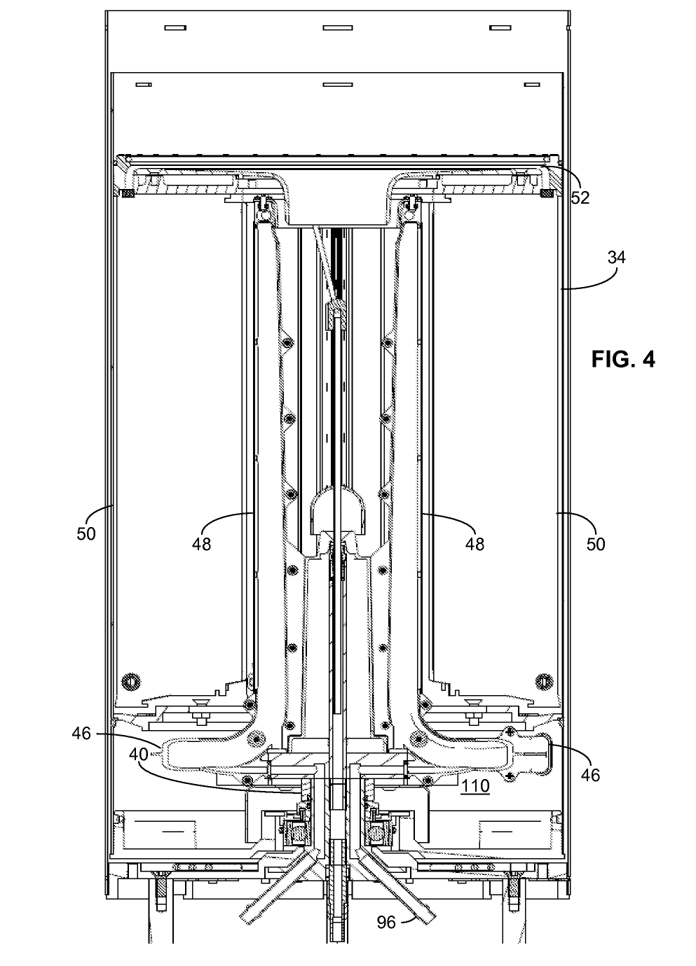

Most of the heat exchanger's operation is of only ancillary interest in the present context, and in any event the above-mention Zebuhr patent application describes it in detail. We therefore set forth only a brief summary, by reference to FIGS. 3 and 4.

FIG. 3 is a simplified cross-sectional view of the shell. Most of the structure inside the shell is a rotary heat exchanger. The rotary heat exchanger, which is the major portion of the second, slower-rotating subassembly, is largely contained within a rotating fluid enclosure comprising a cylindrical rotating-can wall 34 capped by upper and lower end walls 36 and 38. For rotation of the second subassembly within the shell, the upper and lower end walls are respectively journaled onto stationary upper and lower hollow shafts, the lower such shaft being shown in the drawing and identified by reference numeral 40.

A feed-water pump not shown draws feed water from FIG. 1's feed inlet 14 and drives it through the above-mentioned counterflow heat exchanger. After thereby being heated, the feed water ultimately flows into a feed-water conduit that FIG. 3 uses reference numeral 42 to identify. That conduit's outlet 44 delivers the feed water radially into the rotating fluid enclosure's lower end. That enclosure spins so rapidly that centrifugal force drives the feed water radially outward to hug the rotating-can wall 34's interior surface and thereby assume a generally annular shape.

FIG. 4, which is a cross-sectional view taken at a plane orthogonal to FIG. 3's, shows that the stationary assembly of which the lower shaft 40 is a part also includes stationary scoops 46. Mouths formed at the scoops' outer ends skim the sump's rotating feed liquid into interior scoop passages that terminate in sprayers 48. Driven by its kinetic energy, the feed water thus skimmed flows up those passages to respective sprayers 48. The sprayers spray the feed water onto the outer surfaces of radially extending heat-transfer “blades” 50, from which the feed water absorbs heat and thereby partially evaporates. (For the sake of simplicity, all except two of the blades have been omitted from FIG. 3, and all but two others have been omitted from FIG. 4.) The scoops 46 thus serve as the final part of the path that the distiller provides between its feed-liquid inlet and the sprayers by which feed liquid is sprayed onto the heat-exchange surfaces.

Leaving un-evaporated impurities behind, a compressor 52 (whose rotor spins faster than the rotary heat exchanger and thus forms the third, faster-spinning subassembly) draws in the resulting vapor and feeds it pressurized into interior condensation chambers that interior surfaces of the (hollow) blades 50 define. There the pressurized water vapor condenses, surrendering its heat of vaporization through the blade walls to the feed water on the blades' exteriors.

The condensed water is the purified output whose production is the distiller's purpose. The counterflow heat exchanger (not shown) receives that output, cools it by thermal communication with the incoming feed liquid, and delivers it to the condensate outlet, which FIG. 1 uses reference numeral 18 to identify.

As was just explained, only some of the feed water that is sprayed onto the blades' exterior surfaces evaporates. In the illustrated embodiment, in fact, eighty to ninety percent of the sprayer flow remains liquid. The spinning blades 50 (FIG. 4) fling this remaining liquid into an annular feed-water “sump” that, as was also explained above, centrifugal force causes it to form on can wall 34's interior surface so that the scoops 46 can return the un-evaporated feed water to the sprayers 48.

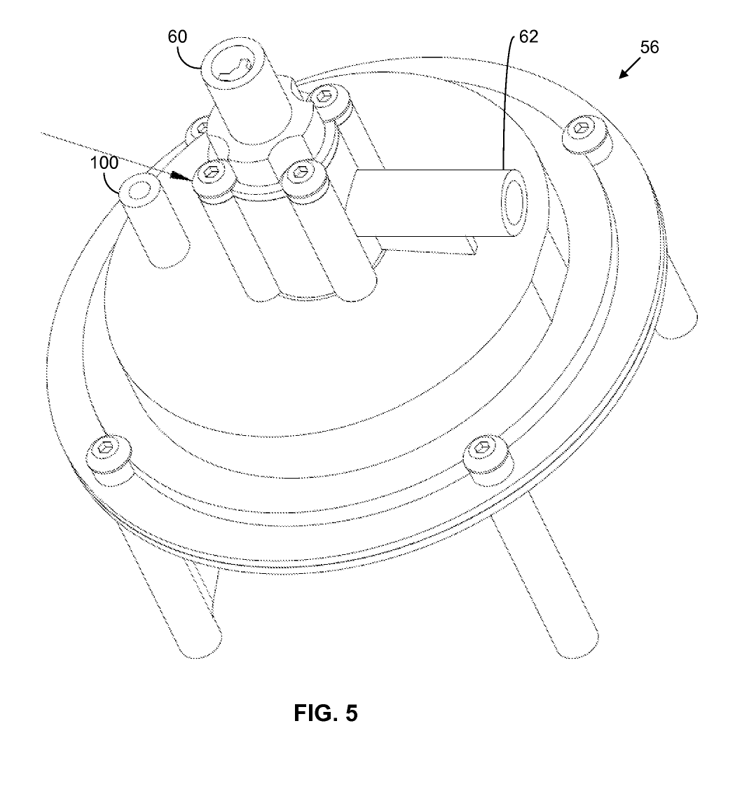

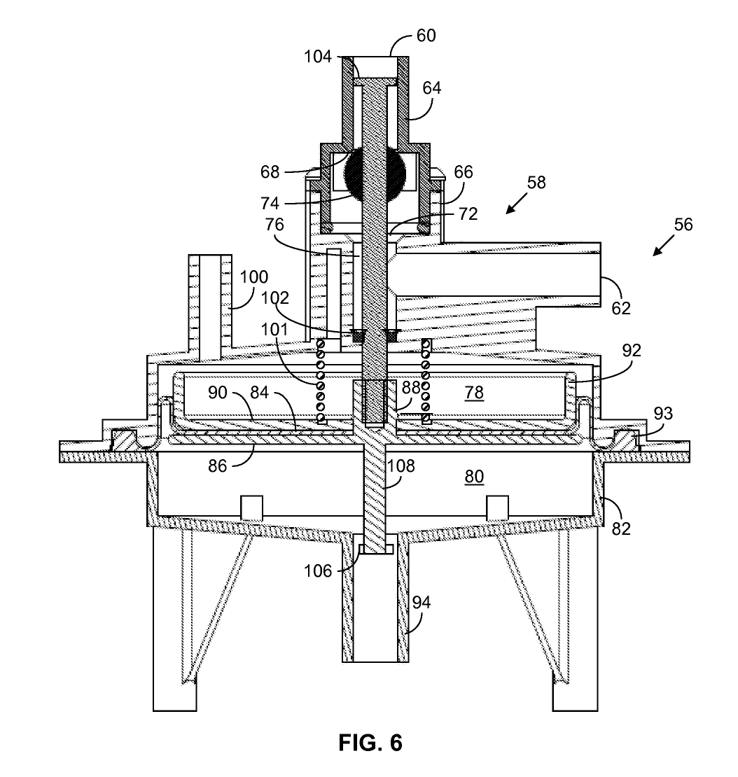

A moment's reflection reveals that the flow through the sprayer 48 should be much greater than the flow through FIG. 3's feed-water conduit 42; conduit 42's flow should be only great enough to replenish the evaporated liquid. But the evaporation rate varies with conditions, and even a slight mismatch between the rates of feed-water flow and evaporation could eventually either deplete the sump or make its depth so great as to compromise the blades' heat-transfer effectiveness. So the system must in some way match the feed-water flow to the evaporation rate. To do this, the illustrated embodiment uses a regulator located under the rotary heat exchanger and identified in FIGS. 5 and 6 by reference numeral 56.

Regulator 56's upper portion 58 is a feed-water valve that is interposed in the fluid path between the above-mentioned feed-water pump and the counterflow heat exchanger's feed-water inlet. The feed-water valve's inlet 60 and outlet 62 are respectively formed by a port member 64 and a regulator upper body member 66, to which the port member 64 is secured. The port member 64 and regulator upper body members 66 form respective valve seats 68 and 72, in which a resilient valve member 74 can alternatively seat in accordance with the position of a valve shaft 76 on which valve member 74 is fixedly mounted.

The shaft 76's position is partially determined by differences between the pressures that prevail in system- and scoop-pressure chambers 78 and 80, which the upper body member 66 and a lower body member 82 cooperate to form with a diaphragm 84 clamped between them. Specifically, the valve shaft 76 is secured in a recess formed by a diaphragm base 86's central protuberance 88, to which a diaphragm cap 90 is snap fit to secure the diaphragm base member 86 onto the diaphragm 84. If the pressure in the scoop-pressure chamber 80 exceeds that in the system-pressure chamber 78, the resultant diaphragm force urges the valve shaft 76 toward the illustrated position. An annular portion of the diaphragm 84 outboard of diaphragm cap 90's outer lip 92 rolls in response to any resultant shaft motion.

An O-ring seal 93 clamped between the diaphragm 84 and the lower body member 82 seals the scoop-pressure chamber 80, and pressure is imposed upon that chamber through a scoop-pressure inlet 94, which the lower body member 82 forms. Specifically, inlet 94 communicates with a pressure conduit, identified in FIG. 4 by reference numeral 96, that leads to the interior of one of the scoops 48.

That scoop's internal pressure is the sum of two components. The larger component is the “system” pressure, i.e., the pressure that prevails generally in the evaporation chamber, in which the sump is disposed. The second component is the additional pressure that results from the kinetic energy of the rotating-sump liquid entering the scoop's mouth. The scoop's mouth normally is only partially submerged in the sump, and the magnitude of that additional pressure therefore depends on the degree of submersion, i.e., on the sump depth. So the sump depth can be sensed by determining the difference between the total scoop pressure and the system pressure.

To that end, a conduit identified in FIG. 3 by reference numeral 98 is provided with an inlet shielded from the sprayer output but exposed to the evaporation-chamber pressure. Conduit 98 leads to a system-pressure inlet identified in FIGS. 5 and 6 by reference numeral 100 and shown by FIG. 5 to be formed by the regulator's upper body member 66. Inlet 100 conveys the system pressure to the system-pressure chamber 78. The pressure force on the diaphragm is therefore proportional to the difference between the scoop and system pressures and thereby indicative of the sump depth.

In operation, the force exerted by a spring 101 on the diaphragm 84 combines with the force caused by the feed-water pressure to keep the valve member 74 spaced downward from the seated position that the drawing depicts. So some feed water flows through the valve to the counterflow heat exchanger and thence to the sump. A cup seal 102 prevents that feed water from leaking into the system-pressure chamber 78.

When the valve member 74 moves downward, the spring 101 relaxes enough that there is ordinarily some valve-member position at which the sum of the forces imposed by spring 101 and the flowing feed water equals the force caused by the difference between the scoop and system pressures. This is the position that the valve member 74 assumes.

If the resultant flow through the valve exceeds the rate at which water evaporates in the rotary heat exchanger, the sump depth increases, so the pressure difference across the diaphragm 84 does, too. The resultant diaphragm force urges the valve member 74 and valve shaft 76 to a higher position, where the valve member 74 permits less flow and experiences greater downward force from the spring 101 and the feed water. Conversely, feed-water flow that is not great enough to replenish the evaporated water results in a sump-depth reduction, with an attendant diaphragm-force reduction and a consequent increase in feed-water flow. As the valve shaft 76's position is thus adjusted, its spider 104 guides it, as does a spider 106 formed by an extension 108 of the diaphragm base member 86.

When the unit is turned off, rotary-heat-exchanger rotation stops, eliminating the centrifugal force on the sump, so the sump liquid falls into an enclosure bottom space identified in FIG. 4 by reference numeral 110. The scoop pressure therefore falls to the system pressure, eliminating the pressure difference across FIG. 6's diaphragm 84. Although the feed-water pump will ordinarily have been turned off, too, residual pressure can remain. Without more, that residual pressure could cause some undesirable remaining flow through the valve. But, since no diaphragm force remains to oppose the force that the spring 101 exerts on the valve member 74, the spring 101 drives the valve member 74 to its rest position in the lower valve seat 72, where it prevents such unwanted flow.

When the unit is then turned on again, heat-exchanger rotation drives the feed liquid back to the annular sump and thereby restores the scoop pressure. The valve member 74's position therefore returns to the range in which the valve operates as described above to match the make-up flow to the rate of evaporation.

As was explained above, the illustrated embodiment uses the evaporation-chamber pressure as its reference—i.e., the pressure difference upon which the illustrated embodiment's controller bases its operation is the difference between the scoop pressure and the evaporation-chamber pressure. This is desirable because it is that pressure difference that is most indicative of the sump depth. But there may be some applications in which using another reference is acceptable.

As their reference pressures, for example, some embodiments may simply use the ambient pressure that prevails in the distiller's vicinity. If the difference between that pressure and the evaporation-chamber pressure does not vary much, this is essentially the same as using the evaporation-chamber pressure for the reference. Such embodiments offer the potential for some simplification; such an embodiment that uses a diaphragm-type controller, for example, can simply expose one side of the diaphragm to ambient pressure and thereby dispense with the conduit between the evaporation chamber and the diaphragm chamber. Variations in the difference between the ambient and evaporation-chamber pressures would cause variations in the level to which sump depth would be controlled, but such variations are acceptable if they remain within appropriate limits.

Also, although the illustrated embodiment uses a purely mechanical regulator, the invention can employ other approaches. For example, the pressure sensor can be a transducer that produces an electrical output on which flow control is based. And, in any case, the scoop pressure could be the basis for, say, controlling pump drive rather than or in addition to a flow-control valve.

In short, basing control of feed-water flow can be implemented simply and effectively in a wide range of embodiments. The invention therefore constitutes a significant advance in the art.

What is claimed is:

1. A distiller comprising:
A) a feed-liquid inlet at which to receive feed liquid to be purified;
B) a sprayer for spraying feed liquid;
C) a rotary-motion source;
D) a rotary heat exchanger forming an evaporation chamber located for reception of feed liquid sprayed by the sprayer, a condensation chamber, heat-transfer members for conducting heat of vaporization from vapor condensing in the condensation chamber to liquid sprayed into the evaporation chamber, and a sump for receiving feed liquid that has passed through the evaporation chamber without evaporating, the rotary heat exchanger being coupled to the rotary-motion source for rotation of the sump's feed liquid about a rotation axis;
E) a feed-liquid path by which the distiller conducts feed liquid from the feed-liquid inlet to the sprayer;
F) a scoop so disposed as to scoop liquid from the sump and direct the liquid thus scooped into the sprayer by internal scoop pressure that results from kinetic energy of the feed liquid in the sump; and
G) a feed-flow controller for, in response to a control pressure difference that equals the amount by which the internal scoop pressure exceeds a reference pressure, so controlling the flow of feed liquid through the feed-liquid path that, throughout an operating range of values of the control pressure difference, the flow of feed liquid through the feed-liquid path varies inversely to the control pressure difference.

2. A distiller as define in claim 1 where in the feed-flow controller includes:
A) a feed-liquid-control valve interposed in the flow-control path and operable among a range of states in which the feed-liquid-control valve offers different resistances to flow of feed liquid through the feed-liquid path; and
B) a valve controller responsive to the control pressure difference for so controlling the feed-liquid-control valve's state that throughout the operating range the feed-liquid-control valve's flow resistance increases and decreases with increases and decreases, respectively, in the control pressure difference.

3. A distiller as defined in claim 2 wherein the valve controller:
A) forms a scoop-pressure chamber in fluid communication with the scoop's interior for transmission of pressure from the scoop's interior to the scoop-pressure chamber; and
B) includes a diaphragm deflectable in response to the scoop-pressure chamber's pressure and so connected to the feed-liquid-control valve as to change the feed-liquid-control valve's state in response to deflection of the diaphragm.

4. A distiller as defined in claim 3 wherein:
A) the valve controller forms a chamber that the diaphragm divides into the scoop-pressure chamber and a system-pressure chamber in such a manner that forces on the diaphragm caused by the scoop- and system-pressure chambers' pressures oppose one another; and
B) the distiller keeps the system-pressure chamber pressure substantially equal to the evaporation chamber's pressure.

5. A distiller as defined in claim 3 wherein the feed-liquid-control valve:
A) forms a rest valve seat; and
B) includes a valve member that is:
i) translatable through a range of positions, in which it permits flow through the feed-liquid-control valve with different flow resistances; and
ii) biased to a rest position in which it seats in the rest valve seat and thereby prevents flow through the feed-liquid control valve.

6. A distiller as defined in claim 5 wherein the diaphragm is operatively connected to the valve member in such a manner that force from the diaphragm caused by the control pressure difference opposes the valve member's bias.

7. A distiller as defined in claim 5 wherein the range of positions through which the valve member is translatable includes a sub-range, spaced from the rest position, in which the flow-control valve's flow resistance increases with the valve member's distance from the rest position.

8. A distiller as defined in claim 2 wherein the reference pressure is the evaporation-chamber pressure.

9. A distiller as defined in claim 2 wherein the valve controller closes the feed-liquid-control valve when the control pressure difference falls below a minimum, which is below the operating range.

10. A distiller as defined in claim 2 wherein the feed-liquid-control valve:
A) forms a rest valve seat; and
B) includes a valve member that is:
i) translatable through a range of positions, in which it permits flow through the feed-liquid-control valve with different flow resistances; and
ii) biased to a rest position in which it seats in the rest valve seat and thereby prevents flow through the feed-liquid control valve.

11. A distiller as defined in claim 10 wherein the range of positions through which the valve member is translatable includes a sub-range, spaced from the rest position, in which the flow-control valve's flow resistance increases with the valve member's distance from the rest position.

12. A distiller as defined in claim 1 wherein the feed-flow controller:
A) forms a scoop-pressure chamber in fluid communication with the scoop's interior for transmission of pressure from the scoop's interior to the scoop-pressure chamber;
B) includes a diaphragm deflectable in response to the scoop-pressure chamber's pressure; and
C) controls the feed-liquid flow in response to the diaphragm's deflection.

13. A distiller as defined in claim 12 wherein:
A) the feed-flow controller forms a chamber that the diaphragm divides into the scoop-pressure chamber and a system-pressure chamber in such a manner that forces on the diaphragm caused by the scoop- and system-pressure chambers' pressures oppose one another; and
B) the distiller keeps the system-pressure chamber pressure substantially equal to the evaporation chamber's pressure.

14. For controlling the flow of feed liquid into a distiller that comprises:
A) a feed-liquid inlet at which to receive feed liquid to be purified;
B) a sprayer for spraying feed liquid;
C) a rotary-motion source;
D) a rotary heat exchanger forming an evaporation chamber located for reception of feed liquid sprayed by the sprayer, a condensation chamber, heat-transfer members for conducting heat of vaporization from vapor condensing in the condensation chamber to liquid sprayed into the evaporation chamber, and a sump for receiving feed liquid that has passed through the evaporation chamber without evaporating, the rotary heat exchanger being coupled to the rotary-motion source for rotation of the sump's feed liquid about a rotation axis;
E) a feed-liquid path by which the distiller conducts feed liquid from the feed-liquid inlet to the sprayer; and
F) a scoop so disposed as to scoop liquid from the sump and direct the liquid thus scooped into the sprayer by internal scoop pressure that results from kinetic energy of the feed liquid in the sump;
a method comprising:
A) sensing a control pressure difference that equals the amount by which the internal scoop pressure exceeds a reference pressure; and
B) in response to the control pressure difference, so controlling the flow of feed liquid through the feed-liquid path that, throughout a range of values of the control pressure difference, the flow of feed liquid therethrough varies inversely to the control pressure difference.

15. A method as defined in claim 14 wherein the reference pressure is the evaporation-chamber pressure.

16. A method as defined in claim 14 that further comprises stopping the flow of feed liquid into the feed-liquid inlet in response to the control pressure difference's falling below a minimum, which is below the operating range.
